(19) United States
(12) Patent Application Publication
(10) Pub. No.: US 2012/0147067 A1
(43) Pub. Date: Jun. 14, 2012

(54) IMAGE DISPLAY DEVICE AND IMAGE DISPLAY METHOD

(75) Inventors: Katsuteru Hashimoto, Osaka-shi (JP); Seiichi Gohshi, Osaka-shi (JP); Katsuya Otoi, Osaka-shi (JP); Kohji Fujiwara, Osaka-shi (JP)

(73) Assignee: SHARP KABUSHIKI KAISHA, Osaka-shi, Osaka (JP)

(21) Appl. No.: 13/391,827

(22) PCT Filed: May 7, 2010
(86) PCT No.: PCT/JP2010/057836

§ 371 Date: Feb. 23, 2012

(30) Foreign Application Priority Data
Sep. 7, 2009 (JP) 2009-205435

(51) Int. Cl. G09G 3/36; G09G 5/10

(52) U.S. Cl. 345/690; 345/102

(57) ABSTRACT

In an image display device of at least one embodiment, a regional maximum detection section detects an areal maximum pixel luminance (regional maximum) on the basis of an input image. A regional mean calculation section calculates an areal mean pixel luminance (regional mean) on the basis of the input image. A data comparison section compares a control determination threshold retained in a control determination threshold storage section with the regional maximum for each area, and outputs a comparison result for that area. An LED output value calculation section sets a value corresponding to the regional maximum as an LED output value for each area with the regional maximum greater than the control determination threshold, and sets a value corresponding to the regional mean as an LED output value for each area with the regional maximum less than or equal to the control determination threshold.

### TECHNICAL FIELD

The present invention relates to image display devices, particularly to an image display device having a function of controlling the luminance of a backlight (backlight dimming function).

### BACKGROUND ART

In image display devices provided with backlights such as liquid crystal display devices, by controlling the luminances of the backlights on the basis of input images, the power consumption of the backlights can be suppressed and the image quality of a displayed image can be improved. In particular, by dividing a screen into a plurality of areas and controlling the luminances of backlight sources corresponding to the areas on the basis of portions of an input image within the areas, it is rendered possible to achieve lower power consumption and higher image quality. Hereinafter, such a method for driving a display panel while controlling the luminances of backlight sources on the basis of an input image in each area will be referred to as “area-active drive”.

Liquid crystal image display devices that perform area-active drive type use, for example, LEDs (light emitting diodes) of three RGB colors or white LEDs, as backlight sources. The following two methods are conventionally known as typical methods for determining the luminances of the LEDs. The first method is a method in which the luminances of LEDs corresponding to an area are determined on the basis of the maximum pixel luminance within the area (hereinafter, referred to as the “max scheme”). The second method is a method in which the luminances of LEDs corresponding to an area are determined on the basis of the mean pixel luminance within the area (hereinafter, referred to as the “mean scheme”). The luminances of LEDs corresponding to each area are obtained by a method as described above or the like, and provided to a driver circuit for a backlight as LED data. In addition, display data (data for controlling the light transmittance of the liquid crystal) is generated on the basis of the LED data and an input image, and the display data is provided to a driver circuit for a liquid crystal panel.

According to a liquid crystal display devices such as that described above, suitable display data and LED data are obtained on the basis of an input image, the light transmittance of the liquid crystal is controlled on the basis of the display data, and the luminances of LEDs corresponding to each area are controlled on the basis of the LED data, whereby an image equivalent to the input image can be displayed on the liquid crystal panel. In addition, when luminances of pixels within an area are low, by reducing luminances of LEDs corresponding to that area, the power consumption of the backlight can be reduced.

Note that Japanese Laid-Open Patent Publication No. 2007-183608 discloses a liquid crystal display device as below. On the basis of maximum unit-pixel tone values (e.g., in the case where values for R, G, and B are 255, 240, and 245, respectively, the maximum is 255), mean tone values (mean unit-region values equal in number to divided regions) are calculated for regions. Thereafter, from the calculated mean unit-region values, a highest mean (the highest among the mean unit-region values), a lowest mean (the lowest among the mean unit-region values), and an overall mean (the mean among the mean unit-region values) are obtained, and a dimming curve is generated such that the luminance of backlight is adjusted, on the basis of these values, and minimum dimming values and maximum dimming values which are set externally. As a result, according to the description therein, some effects such as improved image quality and reduced power consumption can be achieved.

### PRIOR ART DOCUMENTS

### Patent Documents

Patent Document 1: Japanese Laid-Open Patent Publication No. 2007-183608

### DISCLOSURE OF THE INVENTION

### Problems to be Solved by the Invention

However, the max scheme increases power consumption, though the problem of insufficient luminance does not occur. On the other hand, the mean scheme reduces power consumption, but the problem of insufficient luminance occurs. These will be described below with reference to FIGS. 20 to 22. FIG. 20 is a diagram schematically illustrating an exemplary input image. In FIG. 20, it is assumed that a region indicated by the arrow assigned character “81” is a region in which high-tone display is to be performed, and regions indicated by the arrows assigned characters “82” and “83”, respectively, are regions in which low-tone display is to be performed.

When the luminances (of LEDs) for each area are determined by applying the max scheme to the input image shown in FIG. 20, the luminance distribution across the entire screen is, for example, as shown in FIG. 21. Here, looking at the regions indicated by the arrows assigned characters “82” and “83” in FIG. 21, although low-tone display is to be performed there, the luminances are relatively high. The reason for this is that the luminances of the LEDs are determined for each area on the basis of the maximum pixel luminance in that area, so that the luminances of the LEDs are raised when the area includes high-tone pixel data, even if such data is only for one pixel. Therefore, if an input image includes high-tone noise data, the luminances of LEDs are unnecessarily raised, resulting in increased power consumption.

On the other hand, when the luminances for each area are determined by applying the mean scheme to the input image shown in FIG. 20, the luminance distribution across the entire screen is, for example, as shown in FIG. 22. Here, looking at the region indicated by the arrow assigned character “81” in FIG. 22, although high-tone display is to be performed there, the luminances are somehow intermediate. The reason for this is that the luminances of the LEDs are determined for each area on the basis of the mean pixel luminance in that area, so that the luminances of the LEDs are equivalent to those for all of the areas as intermediate tones, if the area includes both high-tone pixel data and low-tone pixel data. Therefore, the insufficient luminance occurs in the regions where high-tone display is to be performed, resulting in reduced image quality.

In the liquid crystal display device disclosed in Japanese Laid-Open Patent Publication No. 2007-183608, the luminances of the LEDs are determined on the basis of mean unit-region values, and therefore, the insufficient luminance occurs when both high-tone pixel data and the low-tone pixel data are included in an area. In addition, if noise data raises the mean unit-region values, dimming values are increased, effects to be achieved are insufficient for reducing power consumption.

Therefore, an objective of the present invention is to achieve low power consumption while suppressing occurrence of insufficient luminance in any region where high-tone display is to be performed, in an image display device which performs area-active drive.

### Solution to the Problems

A first aspect of the present invention is directed to an image display device having a function of controlling backlight luminances, comprising:

a display panel including a plurality of display elements;

a backlight including a plurality of light sources;

a backlight data processing section for dividing an input image into a plurality of areas and obtaining backlight data on the basis of the input image, the backlight data indicating luminances upon emission of the light sources corresponding to the areas;

a display data calculation section for obtaining display data for controlling light transmittances of the display elements, on the basis of the input image and the backlight data;

a panel driver circuit for outputting signals for controlling the light transmittances of the display elements to the display panel, on the basis of the display data; and

a backlight driver circuit for outputting signals for controlling the luminances of the light sources to the backlight, on the basis of the backlight data, wherein,

the backlight data processing section includes:
a threshold data retention section for retaining threshold data which is set for obtaining the backlight data;
a comparison data calculation section for obtaining comparison data for each area on the basis of the input image, the comparison data being intended for comparison with the threshold data;
a data comparison section for comparing the threshold data with the comparison data; and
a backlight data calculation section for obtaining the backlight data for each area in accordance with the result of the comparison by the data comparison section.

According to a second aspect of the present invention, in the first aspect of the present invention,

the backlight data processing section further includes:
an areal maximum detection section for detecting an areal maximum for each area, the areal maximum being a maximum luminance value or a maximum tone value which are based on the input image; and
an areal mean calculation section for calculating an areal mean for each area, the areal mean being a mean luminance value or a mean tone value which are based on the input image, and

the comparison data calculation section sets the areal maximum, the areal mean, or a value obtained by arithmetic processing using the areal maximum and the areal mean, as the comparison data.

According to a third aspect of the present invention, in the second aspect of the present invention,

the comparison data calculation section sets the areal maximum as the comparison data, and

the backlight data calculation section sets a value corresponding to the areal maximum as the backlight data for each area with the comparison data greater than the threshold data and sets a value corresponding to the areal mean as the backlight data for each area with the comparison data less than the threshold data, on the basis of the result of the comparison by the data comparison section.

According to a fourth aspect of the present invention, in the second aspect of the present invention,

the comparison data calculation section sets a value obtained by subtracting the areal mean from the areal maximum, as the comparison data, and

the backlight data calculation section sets a value corresponding to the areal maximum as the backlight data for each area with the comparison data greater than the threshold data and sets a value corresponding to the areal mean as the backlight data for each area with the comparison data less than the threshold data, on the basis of the result of the comparison by the data comparison section.

According to a fifth aspect of the present invention, in the second aspect of the present invention,

the backlight data calculation section obtains the backlight data E1 for each area with the comparison data greater than the threshold data and the backlight data E2 for each area with the comparison data less than the threshold data by their respective equations as follows:

E1=Ma×par11+Me×par12+outpar1×par13, and

E2=Ma×par21+Me×par22+outpar2×par23,

where Ma denotes the areal maximum, Me denotes the areal mean, outpar1 and outpar2 denote values set within a possible value range of the backlight data, and par11, par12, par13, par21, par22, and par23 denote values that are set arbitrarily and externally.

According to a sixth aspect of the present invention, in the first aspect of the present invention,

the backlight data processing section further includes a first histogram generation section for generating a histogram for each area on the basis of the input image, the histogram indicating a occurrence frequency distribution of luminances or tones, and

the comparison data calculation section obtains the comparison data on the basis of the histogram generated by the first histogram generation section.

According to a seventh aspect of the present invention, in the sixth aspect of the present invention,

the comparison data calculation section extracts luminance or tone data indicating an occurrence frequency of a predetermined second specific value or more from luminance or tone data having a predetermined first specific value or more on the basis of the histogram, and sets an average among the extracted data as the comparison data.

According to an eighth aspect of the present invention, in the sixth aspect of the present invention,

the comparison data calculation section extracts luminance or tone data indicating an occurrence frequency of a predetermined fourth specific value or more from luminance or tone data having a predetermined third specific value or more on the basis of the histogram, and obtains an average among the extracted data as a first average,

the comparison data calculation section extracts luminance or tone data indicating an occurrence frequency of the fourth specific value or more from luminance or tone data having a the third specific value or less on the basis of the histogram, and obtains an average among the extracted data as a second average, and

the comparison data calculation section sets a value obtained by subtracting the second average from the first average, as the comparison data.

According to a ninth aspect of the present invention, in the first aspect of the present invention,

the image display device further comprises a threshold data setting section for externally setting the threshold data.

According to a tenth aspect of the present invention, in the first aspect of the present invention,

the backlight data processing section further includes:

a second histogram generation section for generating a histogram indicating a occurrence frequency distribution of luminances or tones for all areas on the basis of the input image; and

a threshold data calculation section for obtaining the threshold data on the basis of the histogram generated by the second histogram generation section.

According to an eleventh aspect of the present invention, in the tenth aspect of the present invention,

the threshold data calculation section sets a luminance or tone with a maximum occurrence frequency among all possible luminances or tones for the input image as the threshold data on the basis of the histogram.

According to a twelfth aspect of the present invention, in the tenth aspect of the present invention,

the threshold data calculation section extracts luminance or tone data indicating an occurrence frequency of a predetermined fifth specific value or more on the basis of the histogram, and sets an average among the extracted data as the threshold data.

A thirteenth aspect of the present invention is directed to an image display method for an image display device provided with a display panel including a plurality of display elements and a backlight including a plurality of light sources, the method comprising:

a backlight data processing step for dividing an input image into a plurality of areas and obtaining backlight data on the basis of the input image, the backlight data indicating luminances upon emission of the light sources corresponding to the areas;

a display data calculation step for obtaining display data for controlling light transmittances of the display elements, on the basis of the input image and the backlight data;

a panel drive step for outputting signals for controlling the light transmittances of the display elements to the display panel, on the basis of the display data; and

a backlight drive step for outputting signals for controlling the luminances of the light sources to the backlight, on the basis of the backlight data, wherein,

the backlight data processing step includes:
a comparison data calculation step for obtaining comparison data for each area on the basis of the input image, the comparison data being intended for comparison with threshold data which is set for obtaining the backlight data;
a data comparison step for comparing the threshold data with the comparison data; and
a backlight data calculation step for obtaining the backlight data for each area in accordance with the result of the comparison in the data comparison step.

In addition, variants that are grasped by referring to the embodiment and the drawings in the thirteenth aspect of the present invention are considered to be means for solving the problems.

### Effect of the Invention

According to the first aspect of the present invention, predetermined threshold data is compared with comparison data obtained for each area on the basis of an input image, and backlight data for controlling luminances of backlight sources is obtained for each area on the basis of the result of the comparison. Therefore, unlike in the conventional art, the backlight data can be obtained by a different method for each area. Thus, the backlight can effectively emit light in accordance with an image to be displayed in each area.

According to the second aspect of the present invention, backlight data is obtained in accordance with the result of comparison between threshold data and an areal maximum pixel luminance or tone value (areal maximum), an areal mean pixel luminance or tone value (areal mean), or a value obtained by arithmetic processing using the areal maximum and the areal mean. Thus, it is possible to obtain backlight luminances considering the maximum and mean values of luminances or tones for each area, so that the backlight can effectively emit light.

According to the third aspect of the present invention, a value corresponding to the areal maximum is set as the backlight data in an area with the areal maximum greater than the threshold data, and a value corresponding to the areal mean is set as the backlight data in an area with the areal maximum less than the threshold data. Accordingly, if an area includes any pixel with its luminance or tone greater than the threshold data, the backlight emits light on the basis of the maximum pixel luminance or tone in that area, and if an area does not include any pixel with its luminance or tone greater than the threshold data, the backlight emits light on the basis of the mean pixel luminance or tone in that area. Thus, by setting the threshold data at an appropriate value, it is rendered possible to reduce power consumption while suppressing occurrence of insufficient luminance in any areas where high-tone display is to be performed.

According to the fourth aspect of the present invention, a value corresponding to the areal maximum is set as the backlight data in an area with the difference between the areal maximum and the areal mean greater than the threshold data, and a value corresponding to the areal mean is set as the backlight data in an area with the difference between the areal maximum and the areal mean less than the threshold data. Accordingly, for example, as for an area in which to display an image with high-tone pixel data being included within a relatively small region of low-tone pixel data, i.e., an image in which occurrence of insufficient luminance is to be suppressed, the backlight emits light on the basis of the maximum pixel luminance or tone in that area, and for example, as for an area which includes an image where high-tone pixel data and low-tone pixel data are irregularly mixed, i.e., noise data, the backlight emits light on the basis of the mean pixel luminance or tone in that area. Thus, by setting the threshold data at an appropriate value, it is rendered possible to suppress occurrence of insufficient luminance in any areas where high-tone display is to be performed, and also possible to suppress an unnecessary increase in power consumption due to the presence of noise data.

According to the fifth aspect of the present invention, two calculation formulae are provided for obtaining the backlight data, and either of the two calculation formulae is used for each area in accordance with the result of comparison between the threshold data and the comparison data. In addition, the two calculation formulae include parameters which are a coefficient for the areal maximum and a coefficient for the areal mean. Thus, by setting the parameter values included in the two calculation formulae at appropriate values, it is rendered possible to reduce power consumption while suppressing occurrence of insufficient luminance in any areas where high-tone display is to be performed.

According to the sixth aspect of the present invention, the comparison data to be compared with the threshold data is obtained on the basis of a histogram generated from the input image. Thus, suitable backlight data can be obtained in accordance with the state of luminance or tone distribution for the input image.

According to the seventh aspect of the present invention, an average of data which occur with a predetermined frequency or higher, out of the luminance or tone data that has a predetermined value or more, is set as the comparison data to be compared with the threshold data. Thus, as in the sixth aspect of the invention, suitable backlight data can be obtained in accordance with the state of luminance or tone distribution for the input image.

According to the eighth aspect of the present invention, the difference between an average of data which occur with a predetermined frequency or higher, out of the luminance or tone data that has a predetermined value or more, and an average of data which occur with a frequency less than the predetermined frequency, out of the luminance or tone data that has the predetermined value or more, is set as the comparison data to be compared with the threshold data. Thus, as in the sixth aspect of the invention, suitable backlight data can be obtained in accordance with the state of luminance or tone distribution for the input image.

According to the ninth aspect of the present invention, the user can directly set the value for the threshold data to be compared with the comparison data.

According to the tenth aspect of the present invention, the value for the threshold data to be compared with the comparison data is set on the basis of a histogram generated from the input image. Thus, suitable backlight data can be obtained in accordance with the state of luminance or tone distribution for the input image.

According to the eleventh aspect of the present invention, a luminance or tone value with the maximum occurrence frequency in the input image is set as the value for the threshold data to be compared with the comparison data. Thus, as in the tenth aspect of the invention, suitable backlight data can be obtained in accordance with the state of luminance or tone distribution for the input image.

According to the twelfth aspect of the present invention, an average among the luminance or tone data which occur with a predetermined frequency or higher in the input image is set as the value for the threshold data. Thus, as in the tenth aspect of the invention, suitable backlight data can be obtained in accordance with the state of luminance or tone distribution for the input image.

### BRIEF DESCRIPTION OF THE DRAWINGS

FIG. 1 is a block diagram illustrating a detailed configuration of an area-active drive processing section in a first embodiment of the present invention.

FIG. 2 is a block diagram illustrating the configuration of a liquid crystal display device according to the first embodiment.

FIG. 3 is a diagram illustrating details of a backlight shown in FIG. 2.

FIG. 4 is a flowchart showing a process by the area-active drive processing section in the first embodiment.

FIG. 5 is a diagram illustrating a luminance spread filter in the first embodiment.

FIG. 6 is a diagram showing the course of action up to obtaining liquid crystal data and LED data in the first embodiment.

FIGS. 7A to 7C are diagrams describing an effect of the first embodiment.

FIG. 8 is a diagram describing an effect of the first embodiment.

FIGS. 9A to 9C are diagrams describing an effect of a variant of the first embodiment.

FIG. 10 is a block diagram illustrating a detailed configuration of an area-active drive processing section in a second embodiment of the present invention.

FIGS. 11A and 11B are diagrams describing an effect of the second embodiment.

FIGS. 12A to 12D are diagrams describing an effect of the second embodiment.

FIG. 13 is a block diagram illustrating a detailed configuration of an area-active drive processing section in a third embodiment of the present invention.

FIG. 14 is a diagram describing how a threshold comparison value is obtained in the third embodiment.

FIG. 15 is a diagram describing how a threshold comparison value is obtained in a variant of the third embodiment.

FIG. 16 is a block diagram illustrating a detailed configuration of an area-active drive processing section in a first variant related to the setting of a control determination threshold.

FIG. 17 is a block diagram illustrating a detailed configuration of an area-active drive processing section in a fourth variant related to the setting of a control determination threshold.

FIG. 18 is a diagram describing how a control determination threshold is obtained in the fourth variant related to the setting of a control determination threshold.

FIG. 19 is a diagram describing how a control determination threshold is obtained in a fifth variant related to the setting of a control determination threshold.

FIG. 20 is a diagram schematically illustrating an exemplary input image.

FIG. 21 is a diagram schematically illustrating a luminance distribution across the entire screen where LED luminances are determined on the basis of the maximum luminance for each area.

FIG. 22 is a diagram schematically illustrating a luminance distribution across the entire screen where LED luminances are determined on the basis of the mean luminance for each area.

### BEST MODE FOR CARRYING OUT THE INVENTION

Hereinafter, embodiments of the present invention will be described with reference to the accompanying drawings.

### 1. First Embodiment

### 1.1 Overall Configuration and Overview of the Operation

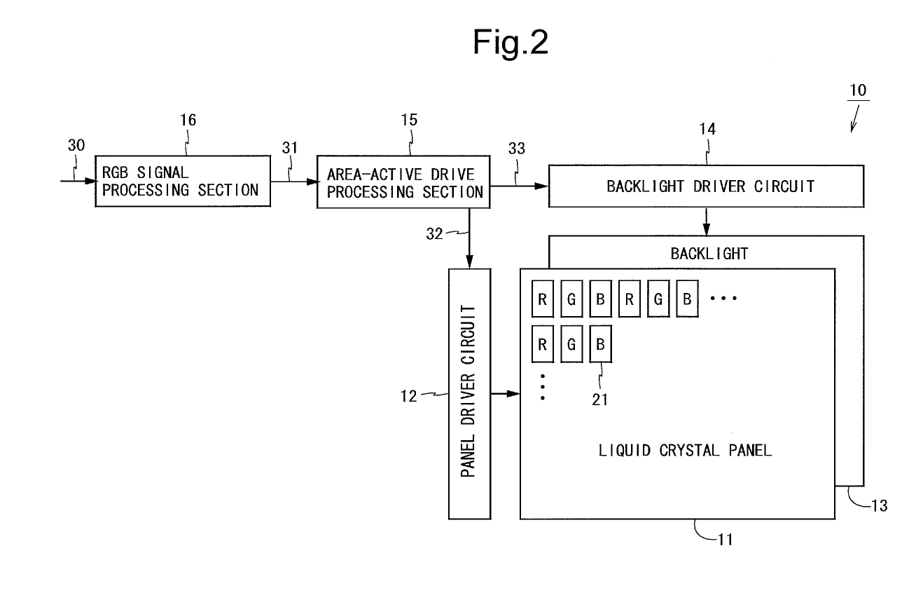

FIG. 2 is a block diagram illustrating the configuration of a liquid crystal display device 10 according to a first embodiment of the present invention. The liquid crystal display device 10 shown in FIG. 2 includes a liquid crystal panel 11, a panel driver circuit 12, a backlight 13, a backlight driver circuit 14, an area-active drive processing section 15, and an RGB signal processing section 16. The liquid crystal display device 10 performs area-active drive in which the liquid crystal panel 11 is driven with luminances of backlight sources being controlled on the basis of input image portions within a plurality of areas defined by dividing the screen. In the following, m and n are integers of 2 or more, p and q are integers of 1 or more, but at least one of p and q is an integer of 2 or more.

The liquid crystal display device 10 receives RGB image signals 30, including R, G, and B images. Each of the R, G, and B images includes luminances for (m×n) pixels. The RGB signal processing section 16 divides the RGB image signals 30 into R, G, and B color components, which are provided to the area-active drive processing section 15 as input images 31 (respectively for the R, G, and B color components). On the basis of the input images 31, the area-active drive processing section 15 obtains display data (hereinafter, referred to as “liquid crystal data 32”) for use in driving the liquid crystal panel 11 and backlight control data (hereinafter, referred to as “LED data 33”) for use in driving the backlight 13 (details will be described later).

The liquid crystal panel 11 includes (m×n×3) display elements 21. The display elements 21 are arranged two-dimensionally as a whole, with each row including 3m of them in its direction (in FIG. 2, horizontally) and each column including n of them in its direction (in FIG. 2, vertically). The display elements 21 include R, G, and B display elements respectively transmitting red, green, and blue light therethrough. The R display elements, the G display elements, and the B display elements are arranged side by side in the row direction, and three display elements form a single pixel. Note that the arrangement of the display elements 21 is not limited to this pattern.

The panel driver circuit 12 is a circuit for driving the liquid crystal panel 11. On the basis of liquid crystal data 32 outputted by the area-active drive processing section 15, the panel driver circuit 12 outputs signals (voltage signals) for controlling light transmittances of the display elements 21 to the liquid crystal panel 11. The voltages outputted by the panel driver circuit 12 are written to pixel electrodes in the display elements 21, and the light transmittances of the display elements 21 change in accordance with the voltages written to the pixel electrodes.

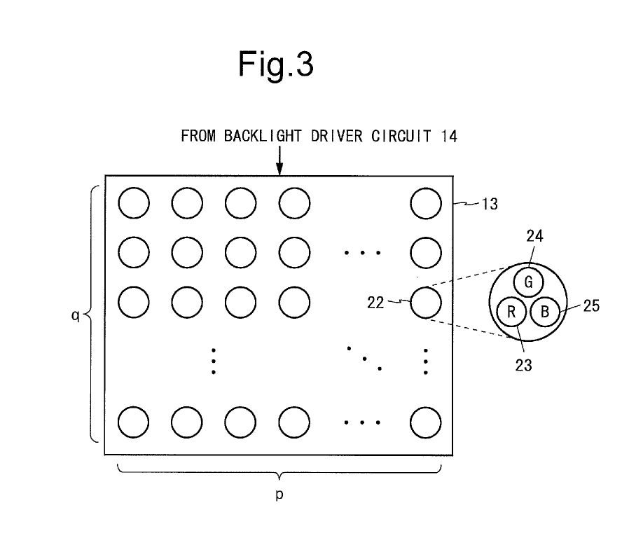

The backlight 13 is provided at the back side of the liquid crystal panel 11 to irradiate backlight light to the back of the liquid crystal panel 11. FIG. 3 is a diagram illustrating details of the backlight 13. The backlight 13 includes (p×q) LED units 22, as shown in FIG. 3. The LED units 22 are arranged two-dimensionally as a whole, with each row including p of them in its direction and each column including q of them in its direction. Each of the LED units 22 includes one red LED 23, one green LED 24, and one blue LED 25. Lights emitted from the three LEDs 23 to 25 included in one LED unit 22 hit a part of the back of the liquid crystal panel 11.

The backlight driver circuit 14 is a circuit for driving the backlight 13. On the basis of LED data 33 outputted by the area-active drive processing section 15, the backlight driver circuit 14 outputs signals (voltage signals or current signals) for controlling luminances of the LEDs 23 to 25 to the backlight 13. The luminances of the LEDs 23 to 25 are controlled independently of luminances of LEDs inside and outside their units.

The screen of the liquid crystal display device 10 is divided into (p×q) areas, each area corresponding to one LED unit 22. For each of the (p×q) areas, the area-active drive processing section 15 obtains the luminance (the luminance upon emission) of the red LEDs 23 that correspond to that area on the basis of an R image within that area. Similarly, the luminance of the green LEDs 24 is determined on the basis of a G image within the area, and the luminance of the blue LEDs 25 is determined on the basis of a B image within the area. The area-active drive processing section 15 obtains luminances for all LEDs 23 to 25 included in the backlight 13, and outputs LED data 33 representing the obtained LED luminances to the backlight driver circuit 14.

Furthermore, on the basis of the LED data 33, the area-active drive processing section 15 obtains luminances of backlight lights (the luminances displayed by backlighting in portions corresponding to the display elements 21) for all display elements 21 included in the liquid crystal panel 11. In addition, on the basis of the input images 31 and the luminances of backlight lights, the area-active drive processing section 15 obtains light transmittances of all of the display elements 21 included in the liquid crystal panel 11, and outputs liquid crystal data 32 representing the obtained light transmittances to the panel driver circuit 12.

In the liquid crystal display device 10, the luminance of each R display element is the product of the luminance of red light emitted by the backlight 13 and the light transmittance of that R display element. Light emitted by one red LED 23 hits a plurality of areas around one corresponding area. Accordingly, the luminance of each R display element is the product of the total luminance of light emitted by a plurality of red LEDs 23 and the light transmittance of that R display element. Similarly, the luminance of each G display element is the product of the total luminance of light emitted by a plurality of green LEDs 24 and the light transmittance of that G display element, and the luminance of each B display element is the product of the total luminance of light emitted by a plurality of blue LEDs 25 and the light transmittance of that B display element.

According to the liquid crystal display device 10 thus configured, the liquid crystal data 32 and the LED data 33, which are data for displaying images on the liquid crystal panel 11, are obtained on the basis of the input images 31. Then, the luminances of the LEDs 23 to 25 are controlled on the basis of the LED data 33, and the light transmittances of the display elements 21 are controlled on the basis of the liquid crystal data 32, so that images corresponding to the externally sent RGB image signals 30 are displayed on the liquid crystal panel 11.

### 1.2 Configuration and Operation of the Area-Active Drive Processing Section

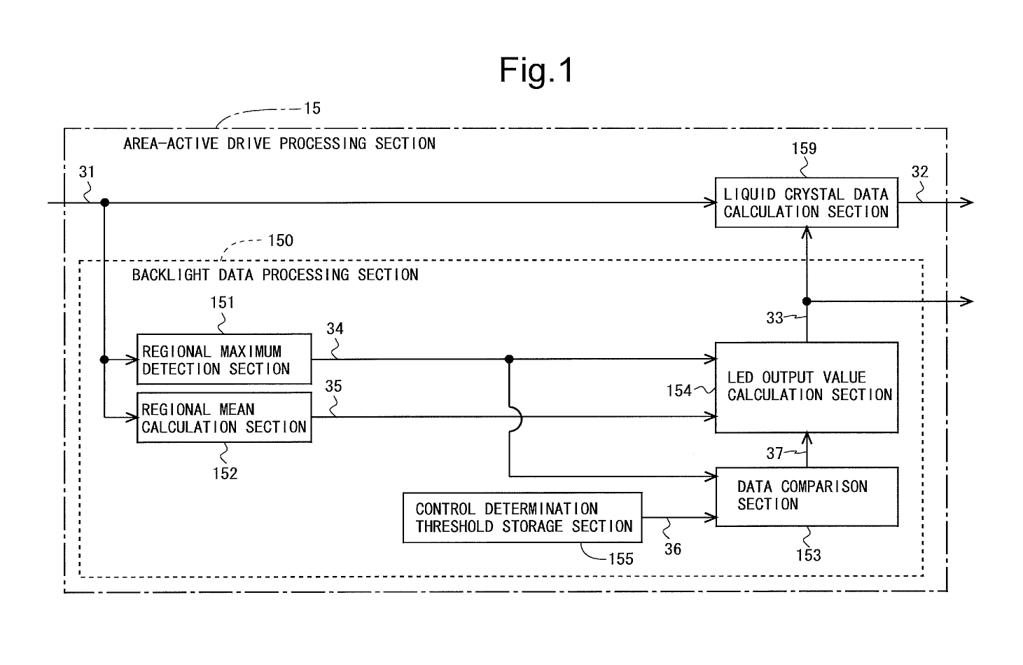

FIG. 1 is a block diagram illustrating a detailed configuration of the area-active drive processing section 15 in the present embodiment. The area-active drive processing section 15 includes a backlight data processing section 150 and a liquid crystal data calculation section 159. The backlight data processing section 150 divides an input image 31 into a plurality of areas, and obtains LED data 33, which indicates luminances upon emission (hereinafter, also referred to as “LED output values”) of LEDs corresponding to the areas, on the basis of the input image 31. The liquid crystal data calculation section 159 obtains liquid crystal data 32, which indicates the light transmittances of all display elements 21 included in the liquid crystal panel 11, on the basis of the input image 31 and the LED data 33.

The backlight data processing section 150 includes, as components for performing a predetermined process, a regional maximum detection section 151, a regional mean calculation section 152, a data comparison section 153, and an LED output value calculation section 154, and also includes a control determination threshold storage section 155 as a component for storing predetermined data.

For each area, the regional maximum detection section 151 detects the maximum pixel luminance in the area on the basis of the input image 31. The detected maximum is outputted from the regional maximum detection section 151 as a regional maximum (areal maximum) 34. For each area, the regional mean calculation section 152 calculates a mean pixel luminance in the area on the basis of the input image 31. The calculated mean is outputted from the regional mean calculation section 152 as a regional mean (areal mean) 35. The control determination threshold storage section 155 has stored therein a control determination threshold 36, which is data required for determining the basis of obtaining LED output values. Note that the control determination threshold 36 needs to be set at an appropriate value such that the backlight 13 (the LEDs 23 to 25) is efficiently lit up.

The data comparison section 153 compares the control determination threshold 36 with the regional maximum 34 for each area, and provides the comparison result 37 for that area to the LED output value calculation section 154. For each area, the LED output value calculation section 154 obtains an LED output value in accordance with the comparison result 37 by the data comparison section 153. At this time, for each area, when the comparison result 37 indicates that the regional maximum 34 is greater than the control determination threshold 36, a value corresponding to the regional maximum 34 (e.g., the regional maximum 34 itself) is set as the LED output value. On the other hand, for each area, when the comparison result 37 indicates that the regional maximum 34 is less than or equal to the control determination threshold 36, a value corresponding to the regional mean 35 (e.g., the regional mean 35 itself) is set as the LED output value.

As described above, in the present embodiment, as for an area having any pixel whose luminance is higher than the control determination threshold 36 which is set in advance, the LED output value is determined on the basis of the maximum pixel luminance in that area. On the other hand, as for an area having no pixel whose luminance is higher than the control determination threshold 36, the LED output value is determined on the basis of the mean pixel luminance in that area. Note that in the present embodiment, the regional maximum detection section 151 realizes both an areal maximum detection section and a comparison data calculation section, the regional mean calculation section 152 realizes an areal mean calculation section, the LED output value calculation section 154 realizes a backlight data calculation section, the control determination threshold storage section 155 realizes a threshold data retention section, and the liquid crystal data calculation section 159 realizes a display data calculation section. In addition, the regional maximum 34 realizes comparison data, and the control determination threshold 36 realizes threshold data.

### 1.3 Processing Procedure by the Area-Active Drive Processing Section

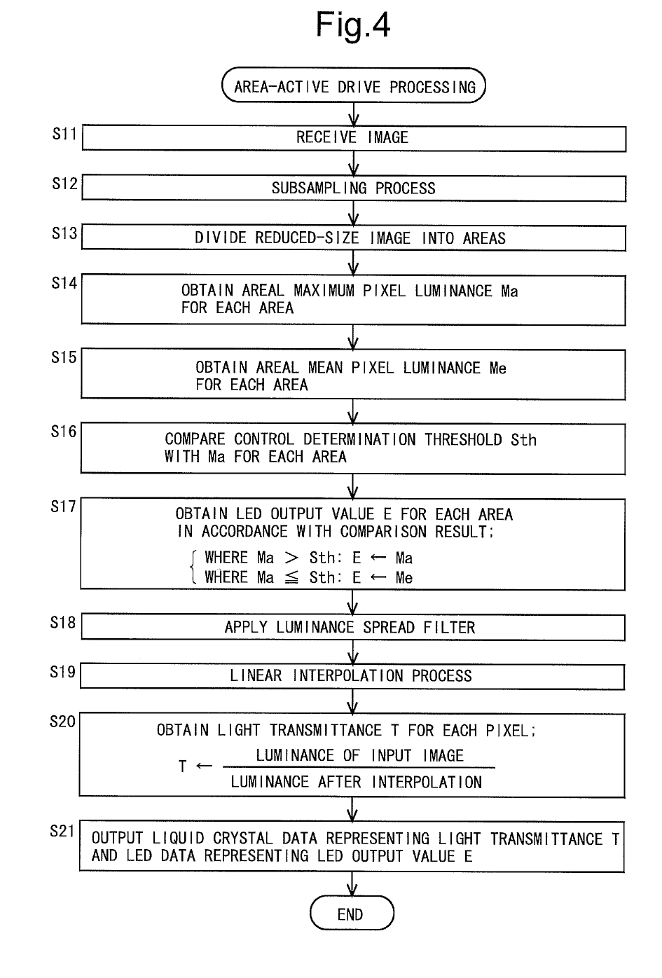

FIG. 4 is a flowchart showing a process by the area-active drive processing section 15. The area-active drive processing section 15 receives an image for a color component (hereinafter, referred to as color component C) included in the input image 31 (step S11). The input image for color component C includes luminances for (m×n) pixels.

Next, the area-active drive processing section 15 performs a subsampling process (averaging process) on the input image for color component C, and obtains a reduced-size image including luminances for (sp×sq) (where s is an integer of 2 or more) pixels (step S12). In step S12, the input image for color component C is reduced to sp/m in the horizontal direction and sq/n in the vertical direction. Then, the area-active drive processing section 15 divides the reduced-size image into (p×q) areas (step S13). Each area includes luminances for (s×s) pixels.

Next, the area-active drive processing section 15 obtains a maximum pixel luminance (regional maximum) Ma for each of the (p×q) areas (step S14). Moreover, the area-active drive processing section 15 obtains a mean pixel luminance (regional mean) Me for each of the (p×q) areas (step S15).

Next, the area-active drive processing section 15 compares the control determination threshold Sth held in the control determination threshold storage section 155 with the maximum pixel luminance Ma for each area obtained in step S14 (step S16). Then, the area-active drive processing section 15 obtains an LED output value E for each of the (p×q) areas in accordance with the result of the comparison of step S16 (step S17). At this time, as for an area whose maximum pixel luminance Ma is greater than the control determination threshold Sth, a value corresponding to the maximum Ma is set as the LED output value E. On the other hand, as for an area whose maximum pixel luminance Ma is less than or equal to the control determination threshold Sth, a value corresponding to the mean Me is set as the LED output value E.

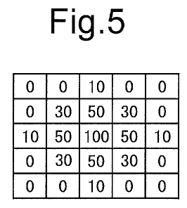

Next, the area-active drive processing section 15 applies a luminance spread filter (point spread filter) to the (p×q) LED output values E obtained in step S17, thereby obtaining first backlight luminance data including (tp×tq) (where t is an integer of 2 or more) luminances (step S18). In step S18, the (p×q) LED output values E are scaled up by a factor of t in both in the horizontal and the vertical direction. Note that the luminance spread filter has stored therein, for example as shown in FIG. 5, PSF data (point spread filter data), which is data indicating how light is spread as numerical values to calculate a display luminance for each area (the luminance being estimated to be achieved by all LEDs emitting light for display in that area).

Next, the area-active drive processing section 15 performs a linear interpolation process on the first backlight luminance data, thereby obtaining second backlight luminance data including (m×n) luminances (step S19). In step S19, the first backlight luminance data is scaled up by a factor of (m/tp) in the horizontal direction and a factor of (n/tq) in the vertical direction. The second backlight luminance data represents luminances of backlight lights for color component C that enter (m×n) display elements 21 for color component C when (p×q) LEDs for color component C emit light with luminances of the LED output values E obtained in step S17.

Next, the area-active drive processing section 15 divides the luminances of the (m×n) pixels included in the input image for color component C respectively by the (m×n) luminances included in the second backlight luminance data, thereby obtaining light transmittances T of the (m×n) display elements 21 for color component C (step S20).

Finally, for color component C, the area-active drive processing section 15 outputs liquid crystal data 32, which represents the (m×n) light transmittances T obtained in step S20, and LED data 33, which represents the (p×q) LED output values E obtained in step S17 (step S21). At this time, the liquid crystal data 32 and the LED data 33 are converted to values within appropriate ranges in conformity with the specifications of the panel driver circuit 12 and the backlight driver circuit 14.

The area-active drive processing section 15 performs the process shown in FIG. 4 on an R image, a G image, and a B image, thereby obtaining liquid crystal data 32 representing (m×n×3) light transmittances and LED data 33 representing (p×q×3) LED output values, on the basis of an input image 31 including luminances for (m×n×3) pixels.

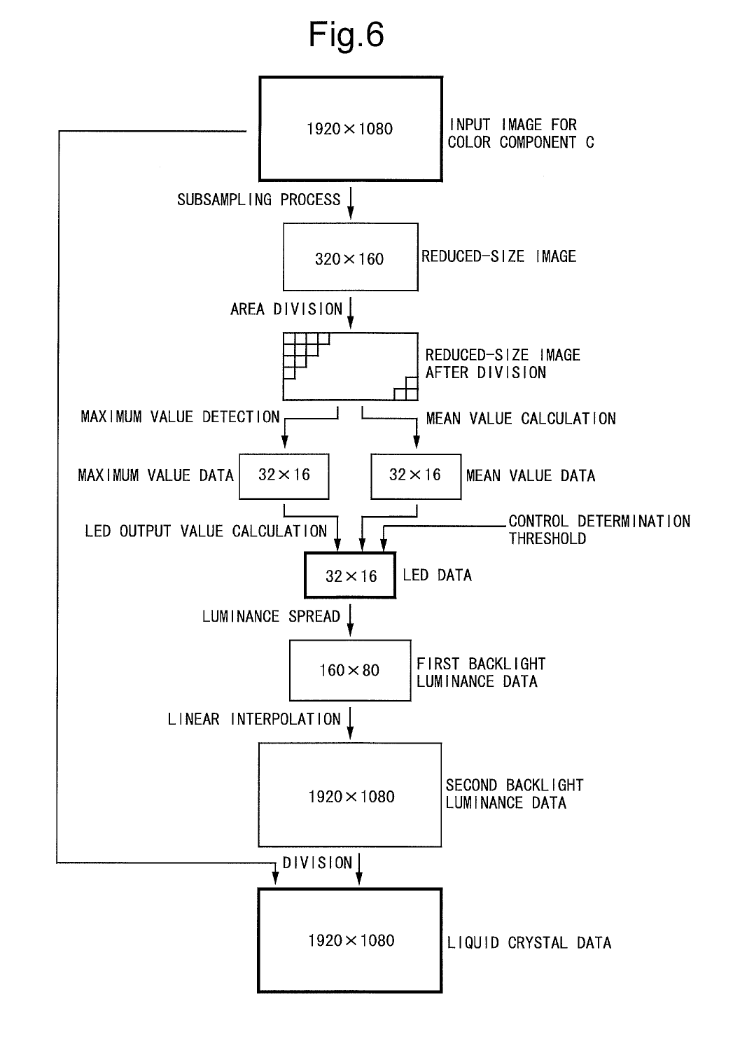

FIG. 6 is a diagram showing the course of action up to obtaining liquid crystal data 32 and LED data 33 where m=1920, n=1080, p=32, q=16, s=10, and t=5. As shown in FIG. 6, a subsampling process is performed on an input image for the color component C, which includes luminances of (1920×1080) pixels, thereby obtaining a reduced-size image including luminances of (320×160) pixels. The reduced-size image is divided into (32×16) areas (the size of each area is (10×10) pixels). For each area, the maximum Ma and the mean Me for the pixel luminances are calculated, thereby obtaining maximum data including (32×16) regional maximums and mean data including (32×16) regional means.

Thereafter, the maximum pixel luminance Ma for each area is compared with the control determination threshold Sth, and the LED output value for that area is obtained in accordance with the result of the comparison, as described above. As a result, LED data 33 for color component C, which represents (32×16) LED output values, is obtained.

Next, the luminance spread filter 17 is applied to the LED data 33 for color component C, thereby obtaining first backlight luminance data including (160×80) luminances. In addition, a linear interpolation process is performed on the first backlight luminance data, thereby obtaining second backlight luminance data including (1920×1080) luminances. Finally, the pixel luminances included in the input image are divided by the luminances included in the second backlight luminance data, thereby obtaining liquid crystal data 32 for the color component C, which includes (1920×1080) light transmittances.

Note that in FIGS. 4 and 6, for ease of explanation, the area-active drive processing section 15 sequentially performs the process on images for color components, but the process may be performed on the images for color components in a time-division manner. Furthermore, in FIGS. 4 and 6, the area-active drive processing section 15 performs a subsampling process on an input image for noise removal and performs area-active drive based on a reduced-size image, but the area active drive may be performed on the basis of the original input image.

### 1.4 Effect

In the present embodiment, in a liquid crystal display device in which area-active drive is performed, the LED output value for each area is determined in the following manner. When an area has any pixel whose luminance is greater than the control determination threshold 36 which is set in advance, the LED output value is determined on the basis of the maximum pixel luminance (regional maximum 34) in that area. On the other hand, when any area has no pixel whose luminance is greater than the control determination threshold 36, the LED output value is determined on the basis of the mean pixel luminance (regional mean 35) in that area. Here, when the control determination threshold 36 is set at an appropriate value, occurrence of insufficient luminance is suppressed in any area including pixels for which high-tone display is to be performed, by determining the LED output value on the basis of the regional maximum 34, and power consumption is reduced in any area not including pixels for which high-tone display is to be performed, by determining the LED output value on the basis of the regional mean 35.

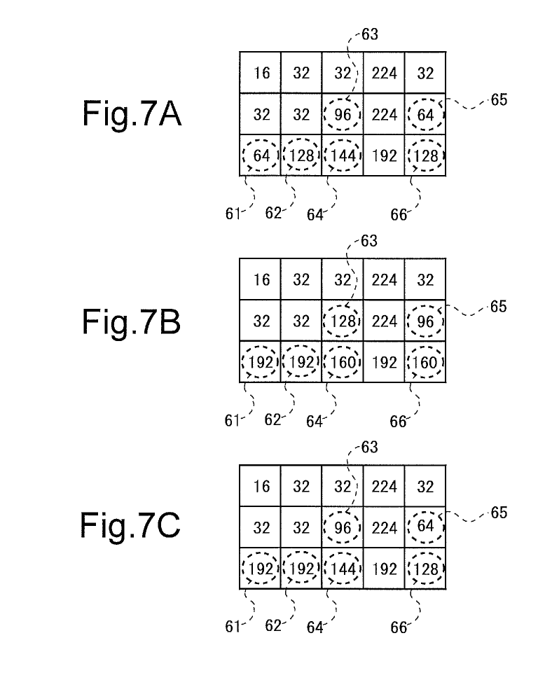

For example, in the case of a liquid crystal display device having its screen divided into (3×5) areas, regional means 35 for areas are assumed to be as shown in FIG. 7A and regional maximums 34 for the areas are assumed to be as shown in FIG. 7B. In addition, the control determination threshold 36 is assumed to be set at “180”. In this case, as for the areas denoted by characters “61” and “62” out of areas which have their regional maximums 34 different from their respective regional means 35, the regional maximums 34 are greater than 180. Accordingly, as for the areas 61 and 62, their regional maximums 34 are set as LED output values. On the other hand, as for the areas denoted by characters “63” to “66” out of areas which have their regional maximums 34 different from their respective regional means 35, the regional maximums 34 are less than 180. Accordingly, as for the areas 63 to 66, their regional means 35 are set as LED output values. As a result, the LED output values for all areas are determined as shown in FIG. 7C.

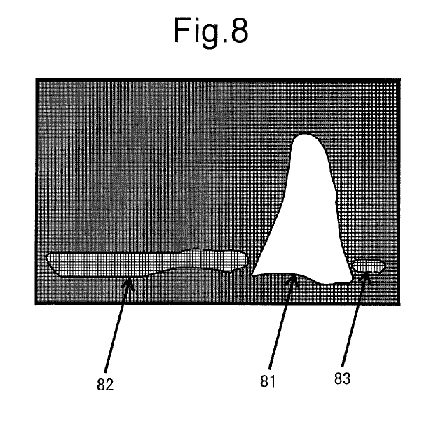

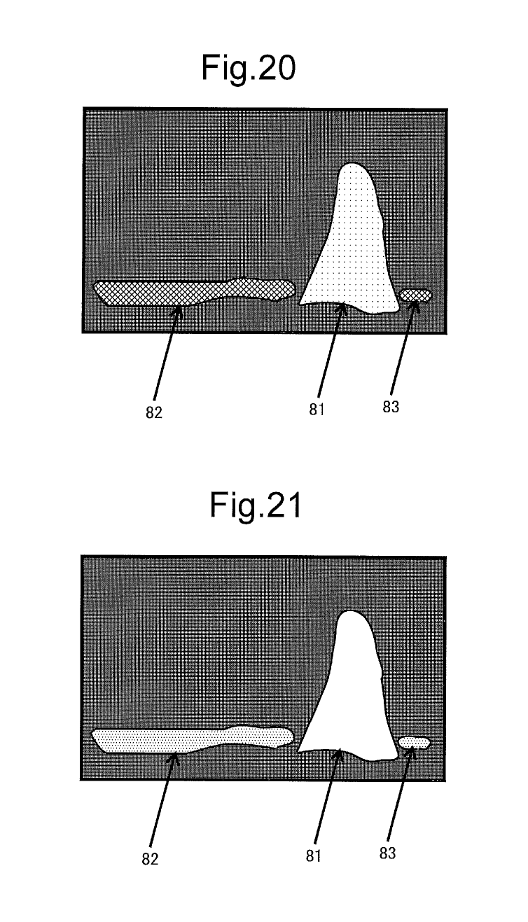

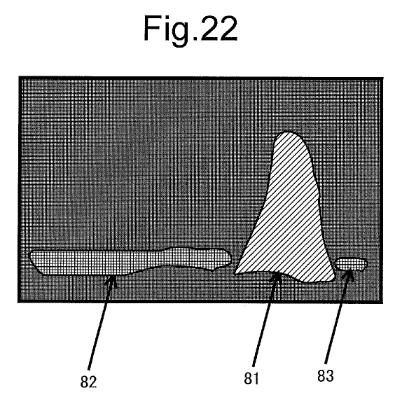

Described next is a luminance distribution across the entire screen as obtained by the input image 31 as shown in FIG. 20 being provided to the area-active drive processing section 15. Looking at the region indicated by the arrow assigned character “81”, areas within that region include high-tone pixel data, and therefore their LED output values are determined on the basis of the regional maximums 34. As a result, LEDs in the region emit light with high luminances. On the other hand, looking at the regions indicated by the arrows assigned characters “82” and “83”, respectively, they are made up of low-tone pixel data and particularly high-tone pixel data is not included (noise data with luminances higher than the control determination threshold 36 are not included), so that their LED output values are determined on the basis of the regional means 35. As a result, LEDs in those regions emit light with low luminances. Therefore, the luminance distribution across the entire screen is as shown in FIG. 8.

As described above, in the present embodiment, LEDs in regions where high-tone display is to be performed emit light with high luminances, and LEDs in other regions emit light with appropriate luminances without emitting light with unnecessarily high luminances. In this manner, low power consumption is achieved while suppressing occurrence of insufficient luminance in regions where high-tone display is to be performed, in the image display device which performs area-active drive.

### 1.5 Variant

In the first embodiment, the LED output value for each area is set at a value corresponding to either the regional maximum 34 or the regional mean 35 in accordance with the result of comparison between the regional maximum 34 and the control determination threshold 36. However, the present invention is not limited to this. The configuration may be such that two calculation formulae for obtaining LED output values are prepared in advance and either of the two calculation formulae is used for each area in accordance with the result of comparison between the regional maximum 34 and the control determination threshold 36. This configuration will be described below.

In the present variant, two calculation formulae for obtaining LED output values are retained in the LED output value calculation section 154 in advance. Concretely, equation (1) is retained in the LED output value calculation section 154 as a calculation formula for obtaining an LED output value E1 for each area having its regional maximum 34 greater than the control determination threshold 36, and equation (2) is retained in the LED output value calculation section 154 as a calculation formula for obtaining an LED output value E2 for each area having its regional maximum 34 less than or equal to the control determination threshold 36.

E1=Ma×par11+Me×par12+outpar1×par13 (1)

E2=Ma×par21+Me×par22+outpar2×par23 (2)

Here, Ma denotes a regional maximum, Me denotes a regional mean, outpar1 and outpar2 denote values to be set within a possible range of LED output values, and par11, par12, par13, par21, par22, and par23 denote values that are set arbitrarily and externally.

By the way, in equation (1), the value for E1 in some cases might exceed a maximum possible value for the LED output value. In such a case, the maximum possible value for the LED output value is set as the value for E1. The same can be said of the value for E2.

In the configuration where two calculation formulae are retained in the LED output value calculation section 154, as mentioned above, the data comparison section 153 compares the control determination threshold 36 with the regional maximum 34 for each area and gives the comparison result 37 to the LED output value calculation section 154 for each area, as in the first embodiment. When the comparison result 37 indicates that the regional maximum 34 is greater than the control determination threshold 36, the LED output value calculation section 154 obtains the LED output value on the basis of equation (1). On the other hand, when the comparison result 37 indicates that the regional maximum 34 is less than or equal to the control determination threshold 36, the LED output value calculation section 154 obtains the LED output value on the basis of equation (2).

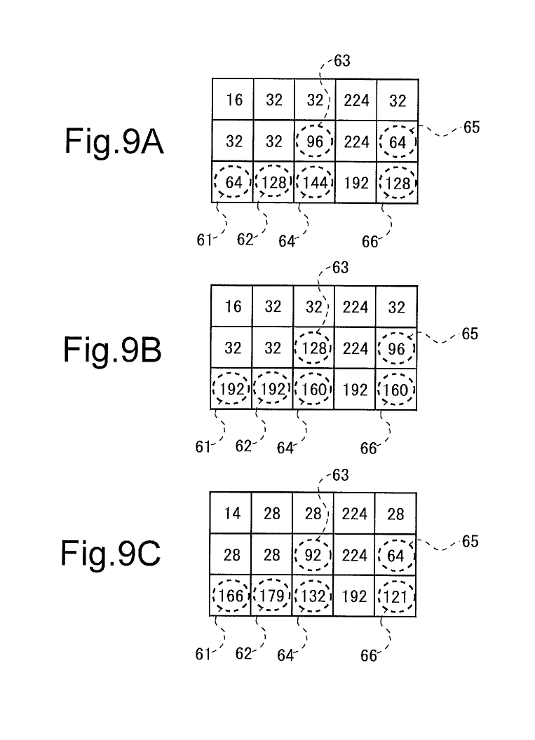

Hereinafter, specific examples will be described. Note that it is assumed that in a liquid crystal display device having its screen divided into (3×5) areas, regional means 35 for the areas are as shown in FIG. 9A and regional maximums 34 for the areas are as shown in FIG. 9B. In addition, the control determination threshold 36, outpar1, outpar2, par11, par12, par13, par21, par22, and par23 are assumed to be set as follows: control determination threshold=180, outpar1=255, outpar2=0, par11=0.8, par12=0.2, par13=0, par21=0.2, par22=0.7, par23=0.1.

Looking at areas 61 to 66 having their regional maximum 34 different from their respective regional means 35 in FIGS. 9A and 9B, LED output values for areas 61 to 66 are calculated as below. Note that calculation results are rounded off to the nearest whole numbers.

As for areas 61 and 62, their regional maximums 34 are greater than 180. Accordingly, on the basis of equation (1), their LED output values are calculated as follows.

area 61: E1=192×0.8+64×0.2+255×0=166

area 62: E1=192×0.8+128×0.2+255×0=179

As for areas 63 to 66, their regional maximums 34 are less than 180. Accordingly, on the basis of equation (2), their LED output values are calculated as follows.

area 63: E2=128×0.2+96×0.7+0×0.1=92

area 64: E2=160×0.2+144×0.7+0×0.1=132

area 65: E2=96×0.2+64×0.7+0×0.1=64

area 66: E2=160×0.2+128×0.7+0×0.1=121

Furthermore, for each area having its regional maximum 34 equal to its regional mean 35, if the regional maximum 34 is greater than the control determination threshold 36, the LED output value is calculated on the basis of equation (1), and if the regional maximum 34 is less than or equal to the control determination threshold 36, the LED output value is calculated on the basis of equation (2). Note that in equation (2), the sum of par21 and par22 is 0.9, and outpar2 is set at 0. Thus, unlike in the first embodiment, as for each area having its regional maximum 34 less than or equal to the control determination threshold 36 out of areas having their regional maximum 34 equal to their respective regional mean 35, the LED output value is less than the regional mean 35(=the regional maximum 34).

In this manner, the LED output value is obtained for each area using equation (1) or (2) in accordance with the result of comparison between the regional maximum 34 and the control determination threshold 36. As a result, the LED output values are determined for all areas as shown in FIG. 9C. In the present variant also, by setting parameters (outpar1, outpar2, par11, par12, par13, par21, par22, and par23) for the calculation formulae for obtaining LED output values at appropriate values, it is rendered possible to reduce power consumption while suppressing occurrence of insufficient luminance in any regions where high-tone display is to be performed.

### 2. Second Embodiment

### 2.1 Configuration and Operation

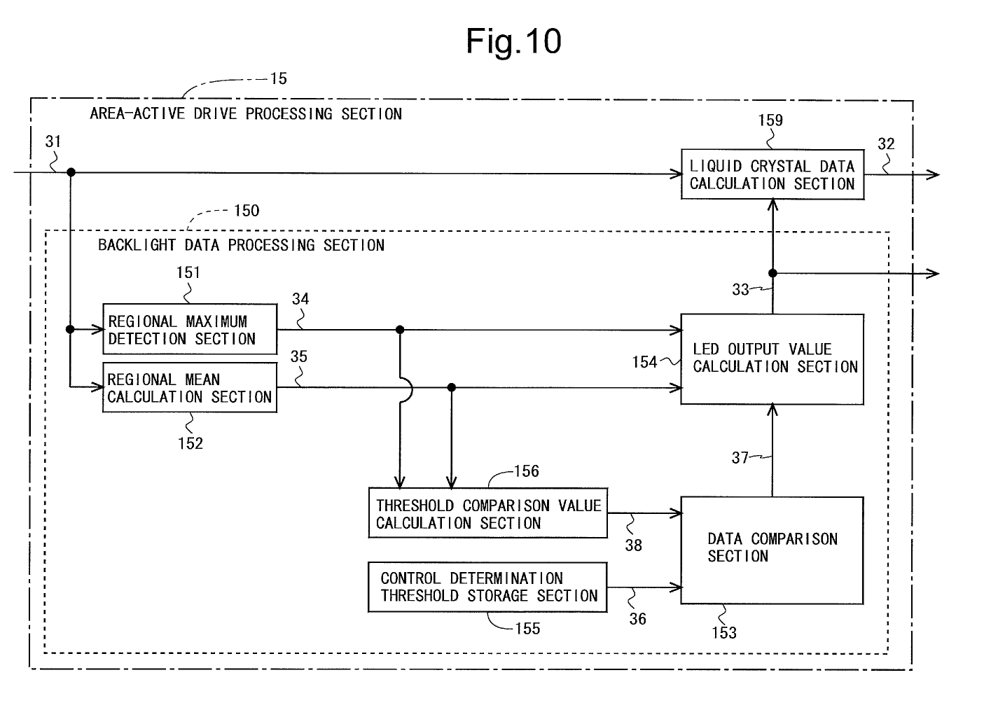

Next, a second embodiment of the present invention will be described. The overall configuration and the general operation are the same as in the first embodiment, and therefore, any descriptions thereof will be omitted (see FIGS. 2 and 3). FIG. 10 is a block diagram illustrating a detailed configuration of an area-active drive processing section 15 in the present embodiment. In the present embodiment, the backlight data processing section 150 is provided with a threshold comparison value calculation section 156 in addition to components as provided in the first embodiment.

The regional maximum detection section 151 and the regional mean calculation section 152 operate in the same manner as in the first embodiment. For each area, the threshold comparison value calculation section 156 receives a regional maximum 34, which is outputted by the regional maximum detection section 151, and a regional mean 35, which is outputted by the regional mean calculation section 152, and outputs a value obtained by subtracting the regional mean 35 from the regional maximum 34, as a value (hereinafter, referred to as a “threshold comparison value”) 38 to be compared with the control determination threshold 36 in the data comparison section 153. The data comparison section 153 compares the control determination threshold 36 with the threshold comparison value 38 for each area, and provides a comparison result 37 for that area to the LED output value calculation section 154. The LED output value calculation section 154 obtains an LED output value for each area in accordance with the comparison result 37 by the data comparison section 153. At this time, for each area, if the comparison result 37 indicates that the threshold comparison value 38 is greater than the control determination threshold 36, a value corresponding to the regional maximum 34 is set as the LED output value. On the other hand, for each area, if the comparison result 37 indicates that the threshold comparison value 38 is less than or equal to the control determination threshold 36, a value corresponding to the regional mean 35 is set as the LED output value.

As described above, in the present embodiment, if the difference between the maximum and the mean pixel luminance in an area is greater than the predetermined control determination threshold 36, the LED output value for the area is determined on the basis of the maximum pixel luminance. On the other hand, the difference between the maximum and the mean pixel luminance in an area is less than or equal to the predetermined control determination threshold 36, the LED output value for the area is determined on the basis of the mean pixel luminance. Note that in the present embodiment, the threshold comparison value calculation section 156 realizes a comparison data calculation section, and the threshold comparison value 38 realizes comparison data.

### 2.2 Effect

According to the present embodiment, in addition to the same effects as those achieved by the first embodiment, the effect of inhibiting backlight luminances from unnecessarily increasing in any areas including noise data is achieved. Hereinafter, this will be described.

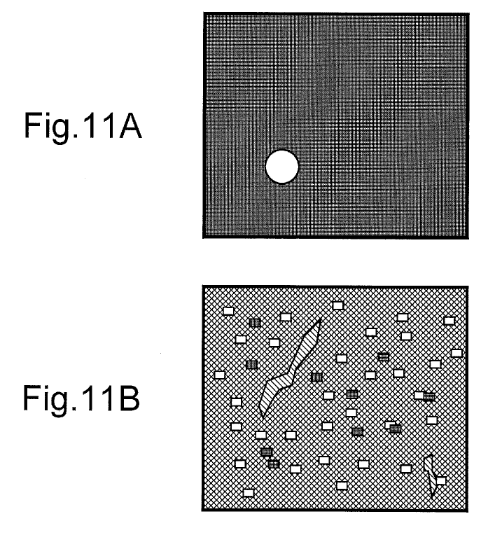

As an image data that includes data for pixels for which high-tone display is to be performed, and in which occurrence of insufficient luminance is to be suppressed, typical example is image data as shown in FIG. 11A, where high-tone pixel data is included within a relatively small part of the low-tone pixel data that spreads in a relatively large region. In addition, a typical example of the noise data is image data as shown in FIG. 11B, where high-tone pixel data and low-tone pixel data are irregularly mixed. Note that each of the image data shown in FIGS. 11A and 11B is image data for one area.

Here, as for the image data as shown in FIG. 11A, the regional maximum 34 is high, and the regional mean 35 is low, so that the difference between the regional maximum 34 and the regional mean 35 is relatively large. On the other hand, as for the image data as shown in FIG. 11B, the regional maximum 34 is high, and the regional mean 35 is intermediate, so that the difference between the regional maximum 34 and the regional mean 35 is relatively small. Accordingly, on the basis of the difference between the regional maximum 34 and the regional mean 35, it is possible to distinguish between the image data as shown in FIG. 11A and the image data as shown in FIG. 11B.

Therefore, in the present embodiment, a value obtained by subtracting the regional mean 35 from the regional maximum 34 is set as the threshold comparison value 38; for each area having its threshold comparison value 38 greater than the control determination threshold 36, the LED output value is determined on the basis of the regional maximum 34, and for each area having its threshold comparison value 38 less than or equal to the control determination threshold 36, the LED output value is determined on the basis of the regional mean 35. Thus, when the control determination threshold 36 is set at an appropriate value in advance, occurrence of insufficient luminance is suppressed in the area for the image data as shown in FIG. 11A, by determining the LED output value on the basis of the regional maximum 34, and power consumption is reduced in the area for the image data as shown in FIG. 11B, by determining the LED output value on the basis of the regional mean 35.

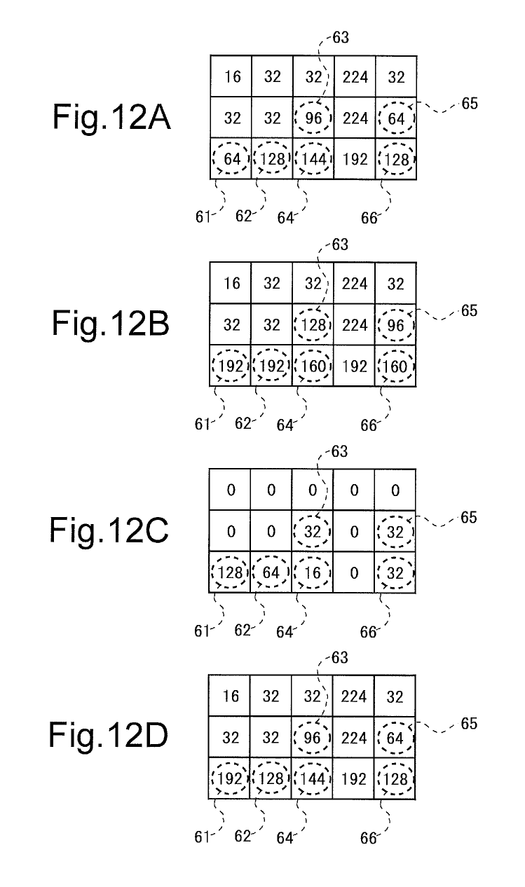

For example, it is assumed that in a liquid crystal display device having its screen divided into (3×5) areas, regional means 35 for the areas are as shown in FIG. 12A and regional maximums 34 for the areas are as shown in FIG. 12B. In addition, the control determination threshold 36 is assumed to be set at “100”. In this case, the threshold comparison value (the difference between the regional maximum 34 and the regional mean 35) for each area is as shown in FIG. 12C. Here, attention is focused on areas 61 to 66 having their threshold comparison values 38 other than 0. As for area 61, the threshold comparison value 38 is greater than 100. Accordingly, as for area 61, the regional maximum 34 is set as an LED output value. On the other hand, as for areas 62 to 66, their threshold comparison values 38 are less than 100. Accordingly, as for areas 62 to 66, their regional means 35 are set as LED output values. As a result, the LED output values for all areas are determined as shown in FIG. 12D.

As described above, in the present embodiment, considering that, for the noise data, the difference between the regional maximum 34 and the regional mean 35 is relatively small, the LED output value is determined in accordance with the result of the comparison of the predetermined control determination threshold 36 with the difference between the regional maximum 34 and the regional mean 35. At this time, for each area with the difference between the regional maximum 34 and the regional mean 35 less than or equal to the control determination threshold 36, the LED output value is determined on the basis of the regional mean 35. Thus, it is possible to inhibit backlight luminances from unnecessarily increasing in any areas including noise data, so that power consumption is further reduced.

### 2.3 Other

In the present embodiment, as in the first embodiment, the configuration may be such that two calculation formulae for obtaining LED output values are prepared in advance and either of the two calculation formulae is used for each area in accordance with the result of comparison between the regional maximum 34 and the control determination threshold 36 (the configuration in the variant of the first embodiment).

### 3. Third Embodiment

### 3.1 Configuration and Operation

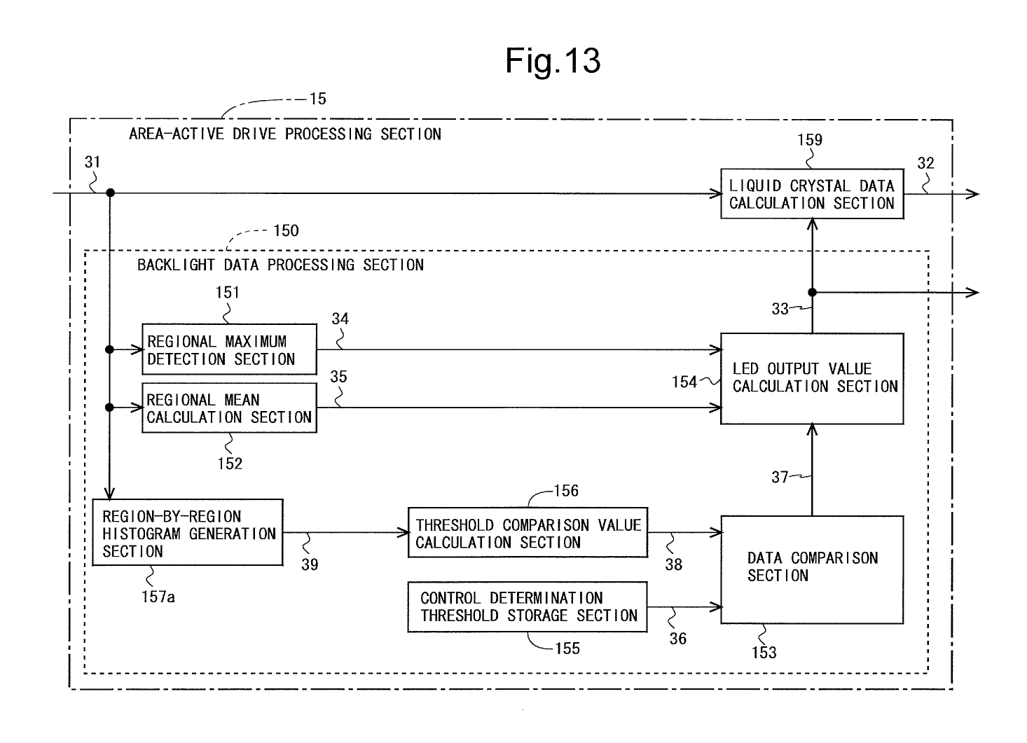

Next, a third embodiment of the present invention will be described. The overall configuration and the general operation are the same as in the first embodiment, and therefore, any descriptions thereof will be omitted (see FIGS. 2 and 3). FIG. 13 is a block diagram illustrating a detailed configuration of an area-active drive processing section 15 in the present embodiment. In the present embodiment, the backlight data processing section 150 is provided with a region-by-region histogram generation section 157a and a threshold comparison value calculation section 156 in addition to components as provided in the first embodiment.

The regional maximum detection section 151 and the regional mean calculation section 152 operate in the same manner as in the first embodiment. For each area, the region-by-region histogram generation section 157a generates a histogram 39 indicating an occurrence frequency distribution of individual luminance values, on the basis of input images 31. For each area, the threshold comparison value calculation section 156 obtains a threshold comparison value 38 on the basis of the histogram 39 generated by the region-by-region histogram generation section 157a. The data comparison section 153 and the LED output value calculation section 154 operate in the same manner as in the second embodiment.

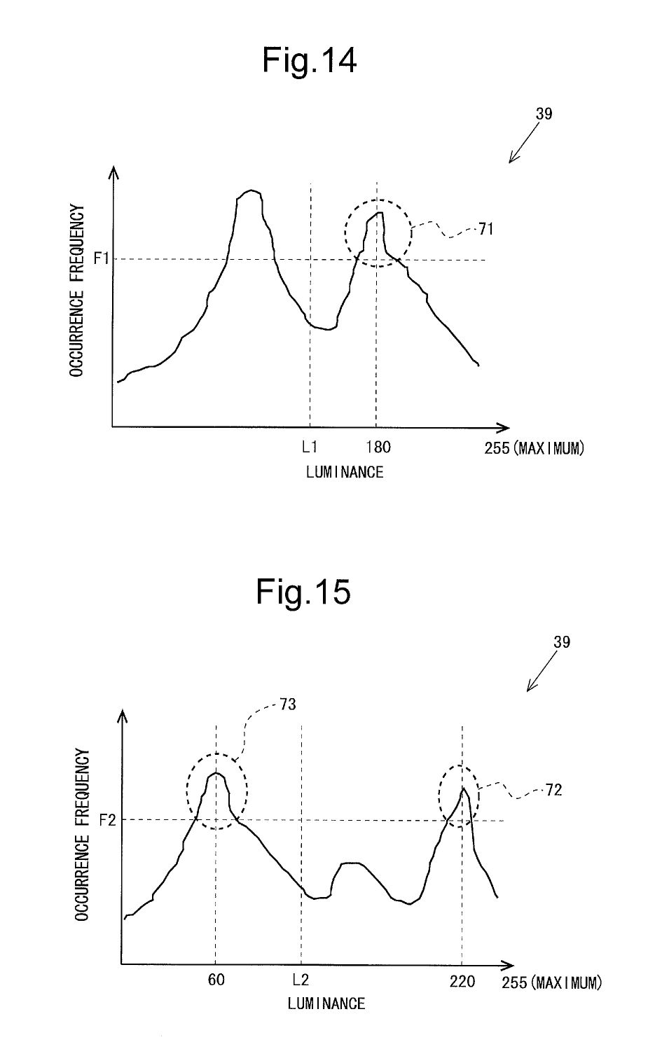

Described next is how the threshold comparison value calculation section 156 obtains the threshold comparison value 38. It is assumed here that a histogram 39 as shown in FIG. 14 is obtained for a certain area. Note that in FIG. 14, the horizontal axis represents the luminance value, and the vertical axis represents the occurrence frequency. In the present embodiment, a luminance value parameter L1 and an occurrence frequency parameter F1 are provided as parameters for use in obtaining the threshold comparison value 38. In addition, the values are set to the luminance value parameter L1 and the occurrence frequency parameter F1 in advance in accordance with, for example, the degree of the user's needs regarding suppression of insufficient luminance and reduction of power consumption.

On the basis of the histogram 39, the threshold comparison value calculation section 156 initially extracts data with a luminance value greater than or equal to the value for the luminance value parameter L1 and with an occurrence frequency greater than or equal to the value for the occurrence frequency parameter F1. As a result, data within the portion indicated by character “71” in FIG. 14 is extracted. The threshold comparison value calculation section 156 then obtains an average luminance value for the extracted data. The average thus obtained is set as the threshold comparison value 38 in the present embodiment. In the example shown in FIG. 14, the threshold comparison value 38 is “180”.

As described above, in the present embodiment, as for each area with the threshold comparison value 38 obtained on the basis of the histogram 39 greater than the control determination threshold 36, the LED output value is determined on the basis of the maximum pixel luminance in that area, and as for each area with the threshold comparison value 38 obtained on the basis of the histogram 39 less than or equal to the control determination threshold 36, the LED output value is determined on the basis of the mean pixel luminance in that area. Note that in the present embodiment, the region-by-region histogram generation section 157a realizes a first histogram generation section. In addition, the value for the luminance value parameter L1 corresponds to a first predetermined value, and the value for the occurrence frequency parameter F1 corresponds to a second predetermined value.

### 3.2 Effect

In the present embodiment, by setting values for the parameters (the luminance value parameter L1 and the occurrence frequency parameter F1) for obtaining the threshold comparison value 38 appropriately in accordance with the user's needs and so on, as in the first and second embodiments, low power consumption can be achieved while suppressing occurrence of insufficient luminance in any regions where high-tone display is to be performed, in the image display device which performs area-active drive.

### 3.3 Variant

Next a variant of the third embodiment will be described. The present variant differs from the third embodiment only in the method of obtaining the threshold comparison value 38 in the threshold comparison value calculation section 156, and therefore, only the method of obtaining the threshold comparison value 38 will be described below. Note that it is assumed here that a histogram 39 as shown in FIG. 15 is obtained for a certain area.

In the present variant, a luminance value parameter L2 and an occurrence frequency parameter F2 are provided as parameters for use in obtaining the threshold comparison value 38. In addition, as in the third embodiment, the values are set to the luminance value parameter L2 and the occurrence frequency parameter F2 in advance in accordance with, for example, the degree of the user's needs regarding suppression of insufficient luminance and reduction of power consumption. Note that in the present variant, the value for the luminance value parameter L2 corresponds to a third predetermined value, and the value for the occurrence frequency parameter F2 corresponds to the a fourth predetermined value.

On the basis of the histogram 39, the threshold comparison value calculation section 156 initially extracts data with a luminance value greater than or equal to the value for the luminance value parameter L2 and with an occurrence frequency greater than or equal to the value for the occurrence frequency parameter F2. As a result, data within the portion indicated by character “72” in FIG. 15 is extracted. The threshold comparison value calculation section 156 then obtains an average luminance value for the extracted data. The average thus obtained is set here as a first average Ave1. Next, on the basis of the histogram 39, the threshold comparison value calculation section 156 extracts data with a luminance value less than the value for the luminance value parameter L2 and with an occurrence frequency greater than or equal to the value for the occurrence frequency parameter F2. As a result, data within the portion indicated by character “73” in FIG. 15 is extracted. The threshold comparison value calculation section 156 then obtains an average luminance value for the extracted data. The average thus obtained is set here as a second average

Ave2. Moreover, the threshold comparison value calculation section 156 subtracts the second average Ave2 from the first average Ave1. The value obtained by this subtraction is set as the threshold comparison value 38 in the present embodiment. In the example shown in FIG. 15, the first average Ave1 is “220”, and the second average Ave2 is “60”. Accordingly, the threshold comparison value 38 is the value obtained by subtracting “60” from “220”, which is “160”.

By determining the LED output value in accordance with the result of comparison between the threshold comparison value 38 as obtained above and the control determination threshold 36, low power consumption can be achieved while suppressing occurrence of insufficient luminance in any regions where high-tone display is to be performed, in the image display device which performs area-active drive.

### 4. Variants Related to the Setting of the Control Determination Threshold

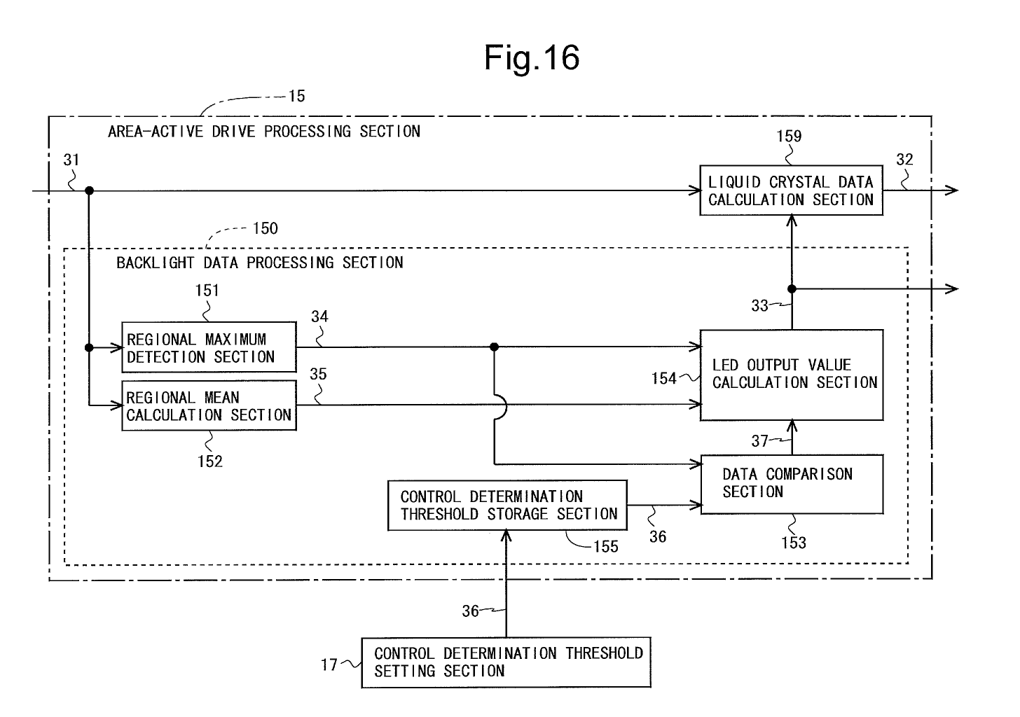

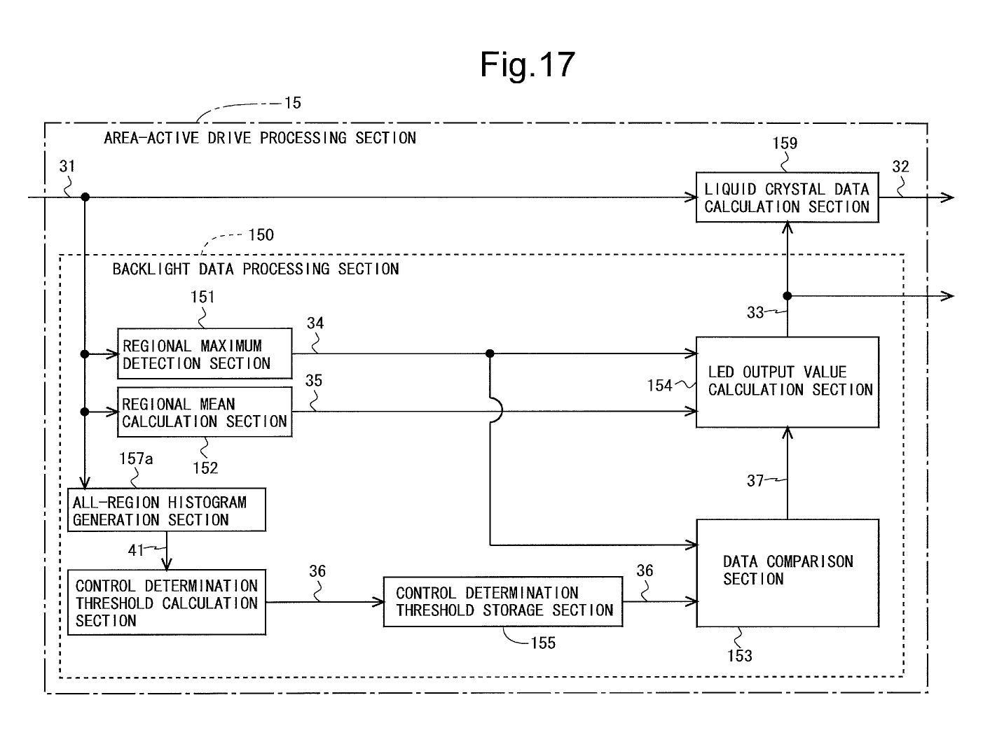

In the above embodiments, the control determination threshold 36 which is set in advance is stored in the control determination threshold storage section 155, but the present invention is not limited to this. Hereinafter, various variants related to the setting of the control determination threshold 36 will be described. Note that FIGS. 16 and 17 to be described below illustrate variants on the configuration of the area-active drive processing section 15 in the first embodiment (FIG. 1), but the configurations in the second and third embodiments (FIGS. 10 and 13) can be modified in the same manner.

### 4.1 First Variant

FIG. 16 is a block diagram illustrating a detailed configuration of an area-active drive processing section 15 in a first variant. In the present variant, a control determination threshold setting section 17 is provided to set the control determination threshold 36 from outside the area-active drive processing section 15, as shown in FIG. 16. Concretely, for example, a GUI (graphical user interface) screen is provided as the control determination threshold setting section 17, and a value inputted by the user via the GUI screen is stored to the control determination threshold storage section 155 as the control determination threshold 36. In this manner, according to the present variant, the user can directly set the control determination threshold 36.

### 4.2 Second Variant

In the present variant, as in the first variant, the area-active drive processing section 15 is configured as shown in FIG. 16. The control determination threshold setting section 17 in the present variant sets the control determination threshold 36 in accordance with the state of the liquid crystal display device 10 (the mode set by the user). For example, four modes, “dynamic mode”, “standard mode”, “movie mode”, and “PC mode”, are assumed to be provided in the liquid crystal display device 10 as AV position modes (these modes being provided for the user to adjust the image quality to suit his/her preference). It is also assumed that the modes are associated in advance with the control determination threshold 36 as follows: dynamic mode: 50; standard mode: 150; movie mode: 200; PC mode: 255. In this case, if the user selects the movie mode, the control determination threshold setting section 17 stores a value of “200”, which is associated with the movie mode, to the control determination threshold storage section 155 as the control determination threshold 36. In this manner, in the present variant, the control determination threshold 36 is set in accordance with the mode selected by the user (which indicates the state of the liquid crystal display device 10).

### 4.3 Third Variant

In the present variant, as in the first variant, the area-active drive processing section 15 is configured as shown in FIG. 16. The control determination threshold setting section 17 in the present variant sets the control determination threshold 36 in accordance with the content set by the user via a remote controller or suchlike. For example, the liquid crystal display device 10 is assumed to be provided with the function of allowing (the user to make) selection of a peak luminance from among four options, “high”, “mid”, “low”, and “off”. It is also assumed that the options are associated in advance with the control determination threshold 36 as follows: high: 50; mid: 100; low: 200; off: 255. In this case, if the user selects the option “high”, the control determination threshold setting section 17 stores a value of “50”, which is associated with the option “high”, to the control determination threshold storage section 155 as the control determination threshold 36. In this manner, in the present variant, the control determination threshold 36 is set in accordance with one of the prepared options that has been selected by the user.

### 4.4 Fourth Variant

FIG. 17 is a block diagram illustrating a detailed configuration of an area-active drive processing section 15 in a fourth variant. In the present variant, the backlight data processing section 150 is provided with an all-region histogram generation section 157b and a control determination threshold calculation section 158, in addition to components as provided in the embodiments. Note that the all-region histogram generation section 157b realizes a second histogram generation section, and the control determination threshold calculation section 158 realizes a threshold data calculation section.

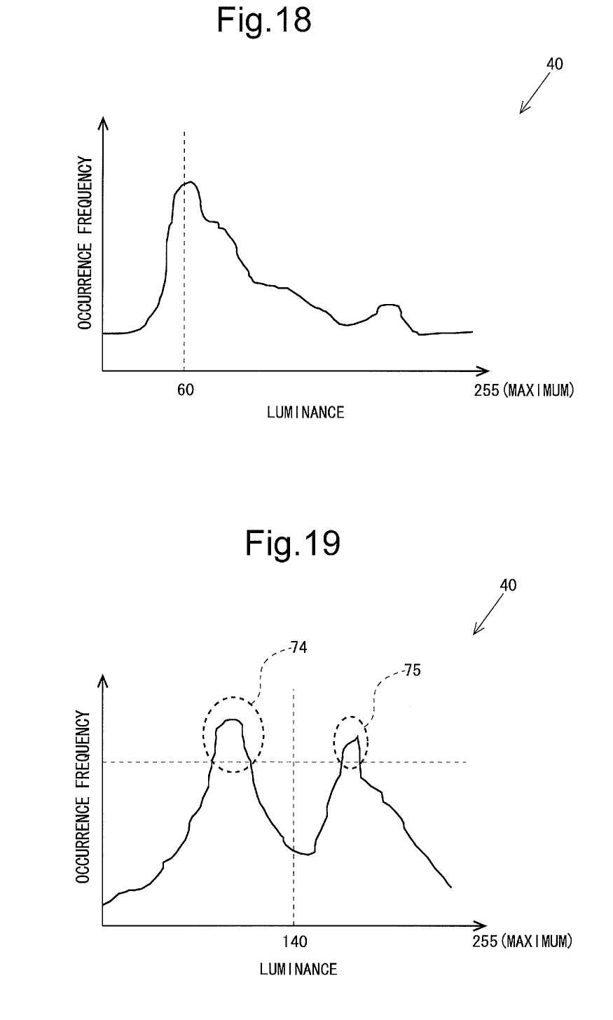

On the basis of an input image 31, the all-region histogram generation section 157b generates a histogram 40 indicating an occurrence frequency distribution of individual luminance values for all areas (rather than on an area-by-area basis). The control determination threshold calculation section 158 obtains the control determination threshold 36 on the basis of the histogram 40, and stored the control determination threshold 36 to the control determination threshold storage section 155. At this time, a luminance value with the maximum occurrence frequency among all luminance values that can be taken by the input image 31 is set as the control determination threshold 36. For example, it is assumed that the histogram 40 as shown in FIG. 18 is generated by the all-region histogram generation section 157b. In this case, the luminance value with the maximum occurrence frequency is “60”, and therefore, the control determination threshold 36 is set to “60”. In this manner, in the present variant, the histogram 40 is generated on the basis of the input image 31, and the luminance value with the maximum occurrence frequency is set as the control determination threshold 36.

### 4.5 Fifth Variant

In the present variant, as in the fourth variant, the area-active drive processing section 15 is configured as shown in FIG. 17. However, the method for obtaining the control determination threshold 36 in the control determination threshold calculation section 158 differs from that in the fourth variant. In the present variant, an occurrence frequency parameter F3 is provided as a parameter for use in obtaining the control determination threshold 36. Note that the occurrence frequency parameter F3 corresponds to a fifth predetermined value.

The control determination threshold calculation section 158 initially extracts data with an occurrence frequency greater than or equal to the value for the occurrence frequency parameter F3 on the basis of the histogram 40 generated by the all-region histogram generation section 157b. The control determination threshold calculation section 158 then obtains an average luminance value for the extracted data. The average thus obtained is set as the control determination threshold 36. For example, it is assumed that the histogram 40 as shown in FIG. 19 is generated by the all-region histogram generation section 157b. In this case, data for the portions indicated by characters “74” and “75” in FIG. 19 is extracted. Then, an average luminance value for the extracted data is calculated. Subsequently, the result of the calculation, “140”, is set as the control determination threshold 36. In this manner, in the present variant, the histogram 40 is generated on the basis of the input image 31, and an average for data with the luminance values that occur with a predetermined frequency or higher is set as the control determination threshold 36.

### 5. Other

The above embodiments have been described taking the liquid crystal display device as an example, but the present invention is not limited to this. In any image display device which has a backlight and performs area-active drive, by obtaining the LED output value for each area in a manner as described above, it is rendered possible to achieve the same effects as those achieved in the case of the liquid crystal display device.

Furthermore, in the above embodiments, the processing for calculating the LED output value is performed using the maximum and mean values for luminance data, but the present invention is not limited to this, and the processing for calculating the LED output value may be performed using the maximum and mean values for tone data.

Furthermore, the above embodiments are premised on LEDs of three colors, R, G, and B (the red LEDs 23, the green LEDs 24, and the blue LEDs 25 in FIG. 3), being used as the backlight 13. However, the present invention can be applied to any configuration using white LEDs as the backlight 13. In this case, there are two conceivable methods for obtaining the LED data 33 that is to be provided to the backlight driver circuit 14. The first method is a method in which the LED output value is obtained for each of the R image, G image, and B image and the maximum among the obtained three LED output values is set as the LED data 33. The second method is a method in which the maximum of the RGB data is extracted for each pixel (for each unit pixel) and the LED output value that is obtained on the basis of the extracted maximums (for all pixels) is set as the LED data 33. Note that the first method is preferable from the viewpoint of general versatility, whereas the second method is preferable from the viewpoint of circuit scale and cost.

### DESCRIPTION OF THE REFERENCE CHARACTERS

10 liquid crystal display device
11 liquid crystal panel
12 panel driver circuit
13 backlight
14 backlight driver circuit
15 area-active drive processing section
16 RGB signal processing section
31 input image
32 liquid crystal data
33 LED data
34 regional maximum
35 regional mean
36 control determination threshold
37 comparison result
38 threshold comparison value
39, 40 histogram
150 backlight data processing section
151 regional maximum detection section
152 regional mean calculation section
153 data comparison section
154 LED output value calculation section
155 control determination threshold storage section
156 threshold comparison value calculation section
157a region-by-region histogram generation section
157b all-region histogram generation section
158 control determination threshold calculation section
159 liquid crystal data calculation section

1. An image display device having a function of controlling backlight luminances, comprising:
a display panel including a plurality of display elements;
a backlight including a plurality of light sources;
a backlight data processing section for dividing an input image into a plurality of areas and obtaining backlight data on the basis of the input image, the backlight data indicating luminances upon emission of the light sources corresponding to the areas;
a display data calculation section for obtaining display data for controlling light transmittances of the display elements, on the basis of the input image and the backlight data;
a panel driver circuit for outputting signals for controlling the light transmittances of the display elements to the display panel, on the basis of the display data; and
a backlight driver circuit for outputting signals for controlling the luminances of the light sources to the backlight, on the basis of the backlight data, wherein,
the backlight data processing section includes:
a threshold data retention section for retaining threshold data which is set for obtaining the backlight data;
a comparison data calculation section for obtaining comparison data for each area on the basis of the input image, the comparison data being intended for comparison with the threshold data;
a data comparison section for comparing the threshold data with the comparison data; and
a backlight data calculation section for obtaining the backlight data for each area in accordance with the result of the comparison by the data comparison section.

2. The image display device according to claim 1, wherein,
the backlight data processing section further includes:
an areal maximum detection section for detecting an areal maximum for each area, the areal maximum being a maximum luminance value or a maximum tone value which are based on the input image; and
an areal mean calculation section for calculating an areal mean for each area, the areal mean being a mean luminance value or a mean tone value which are based on the input image, and
the comparison data calculation section sets the areal maximum, the areal mean, or a value obtained by arithmetic processing using the areal maximum and the areal mean, as the comparison data.

3. The image display device according to claim 2, wherein,
the comparison data calculation section sets the areal maximum as the comparison data, and
the backlight data calculation section sets a value corresponding to the areal maximum as the backlight data for each area with the comparison data greater than the threshold data and sets a value corresponding to the areal mean as the backlight data for each area with the comparison data less than the threshold data, on the basis of the result of the comparison by the data comparison section.

4. The image display device according to claim 2, wherein,
the comparison data calculation section sets a value obtained by subtracting the areal mean from the areal maximum, as the comparison data, and
the backlight data calculation section sets a value corresponding to the areal maximum as the backlight data for each area with the comparison data greater than the threshold data and sets a value corresponding to the areal mean as the backlight data for each area with the comparison data less than the threshold data, on the basis of the result of the comparison by the data comparison section.

5. The image display device according to claim 2, wherein the backlight data calculation section obtains the backlight data E1 for each area with the comparison data greater than the threshold data and the backlight data E2 for each area with the comparison data less than the threshold data by their respective equations as follows:
E1=Ma×par11+Me×par12+outpar1×par13, and
E2=Ma×par21+Me×par22+outpar2×par23,
where Ma denotes the areal maximum, Me denotes the areal mean, outpar1 and outpar2 denote values set within a possible value range of the backlight data, and par 11, par12, par13, par21, par22, and par23 denote values that are set arbitrarily and externally.

6. The image display device according to claim 1, wherein,
the backlight data processing section further includes a first histogram generation section for generating a histogram for each area on the basis of the input image, the histogram indicating a occurrence frequency distribution of luminances or tones, and
the comparison data calculation section obtains the comparison data on the basis of the histogram generated by the first histogram generation section.

7. The image display device according to claim 6, wherein the comparison data calculation section extracts luminance or tone data indicating an occurrence frequency of a predetermined second specific value or more from luminance or tone data having a predetermined first specific value or more on the basis of the histogram, and sets an average among the extracted data as the comparison data.

8. The image display device according to claim 6, wherein,
the comparison data calculation section extracts luminance or tone data indicating an occurrence frequency of a predetermined fourth specific value or more from luminance or tone data having a predetermined third specific value or more on the basis of the histogram, and obtains an average among the extracted data as a first average,
the comparison data calculation section extracts luminance or tone data indicating an occurrence frequency of the fourth specific value or more from luminance or tone data having a the third specific value or less on the basis of the histogram, and obtains an average among the extracted data as a second average, and
the comparison data calculation section sets a value obtained by subtracting the second average from the first average, as the comparison data.

9. The image display device according to claim 1, further comprising a threshold data setting section for externally setting the threshold data.

10. The image display device according to claim 1, wherein the backlight data processing section further includes:
a second histogram generation section for generating a histogram indicating a occurrence frequency distribution of luminances or tones for all areas on the basis of the input image; and
a threshold data calculation section for obtaining the threshold data on the basis of the histogram generated by the second histogram generation section.

11. The image display device according to claim 10, wherein the threshold data calculation section sets a luminance or tone with a maximum occurrence frequency among all possible luminances or tones for the input image as the threshold data on the basis of the histogram.

12. The image display device according to claim 10, wherein the threshold data calculation section extracts luminance or tone data indicating an occurrence frequency of a predetermined fifth specific value or more on the basis of the histogram, and sets an average among the extracted data as the threshold data.

13. An image display method for an image display device provided with a display panel including a plurality of display elements and a backlight including a plurality of light sources, the method comprising:
a backlight data processing step for dividing an input image into a plurality of areas and obtaining backlight data on the basis of the input image, the backlight data indicating luminances upon emission of the light sources corresponding to the areas;
a display data calculation step for obtaining display data for controlling light transmittances of the display elements, on the basis of the input image and the backlight data;
a panel drive step for outputting signals for controlling the light transmittances of the display elements to the display panel, on the basis of the display data; and
a backlight drive step for outputting signals for controlling the luminances of the light sources to the backlight, on the basis of the backlight data, wherein, the backlight data processing step includes:
a comparison data calculation step for obtaining comparison data for each area on the basis of the input image, the comparison data being intended for comparison with threshold data which is set for obtaining the backlight data;
a data comparison step for comparing the threshold data with the comparison data; and
a backlight data calculation step for obtaining the backlight data for each area in accordance with the result of the comparison in the data comparison step.

14. The image display method according to claim 13, wherein,
the backlight data processing step further includes:
an areal maximum detection step for detecting an areal maximum for each area, the areal maximum being a maximum luminance value or a maximum tone value which are based on the input image; and
an areal mean calculation step for calculating an areal mean for each area, the areal mean being a mean luminance value or a mean tone value which are based on the input image, and
in the comparison data calculation step, the areal maximum, the areal mean, or a value obtained by arithmetic processing using the areal maximum and the areal mean, is set as the comparison data.

15. The image display method according to claim 14, wherein,
in the comparison data calculation step, the areal maximum is set as the comparison data, and
in the backlight data calculation step, a value corresponding to the areal maximum is set as the backlight data for each area with the comparison data greater than the threshold data, and a value corresponding to the areal mean is set as the backlight data for each area with the comparison data less than the threshold data, on the basis of the result of the comparison in the data comparison step.

16. The image display method according to claim 14, wherein,
in the comparison data calculation step, a value obtained by subtracting the areal mean from the areal maximum is set as the comparison data, and
in the backlight data calculation step, a value corresponding to the areal maximum is set as the backlight data for each area with the comparison data greater than the threshold data, and a value corresponding to the areal mean is set as the backlight data for each area with the comparison data less than the threshold data, on the basis of the result of the comparison in the data comparison step.

17. The image display method according to claim 14, wherein, in the backlight data calculation step, the backlight data E1 for each area with the comparison data greater than the threshold data and the backlight data E2 for each area with the comparison data less than the threshold data are obtained by their respective equations as follows:
E1=Ma×par11+Me×par12+outpar1×par13, and
E2=Ma×par21+Me×par22+outpar2×par23,
where Ma denotes the areal maximum, Me denotes the areal mean, outpar1 and outpar2 denote values set within a possible value range of the backlight data, and par11, par12, par13, par21, par22, and par23 denote values that are set arbitrarily and externally.

18. The image display method according to claim 13, wherein,
the backlight data processing step further includes a first histogram generation step for generating a histogram for each area on the basis of the input image, the histogram indicating a occurrence frequency distribution of luminances or tones, and
in the comparison data calculation step, the comparison data is obtained on the basis of the histogram generated in the first histogram generation step.

19. The image display method according to claim 13, wherein in the comparison data calculation step, luminance or tone data indicating an occurrence frequency of a predetermined second specific value or more is extracted from luminance or tone data having a predetermined first specific value or more on the basis of the histogram, and an average among the extracted data is set as the comparison data.

20. The image display method according to claim 18, wherein,
in the comparison data calculation step, luminance or tone data indicating an occurrence frequency of a predetermined fourth specific value or more is extracted from luminance or tone data having a predetermined third specific value or more on the basis of the histogram, and an average among the extracted data is obtained as a first average,
in the comparison data calculation step, luminance or tone data indicating an occurrence frequency of the fourth specific value or more is extracted from luminance or tone data having the third specific value or less on the basis of the histogram, and an average among the extracted data is obtained as a second average, and
in the comparison data calculation step, a value obtained by subtracting the second average from the first average is set as the comparison data.

21. The image display method according to claim 13, further comprising a threshold data setting step for externally setting the threshold data.

22. The image display method according to claim 13, wherein the backlight data processing step further includes:
a second histogram generation step for generating a histogram indicating a occurrence frequency distribution of luminances or tones for all areas on the basis of the input image; and
a threshold data calculation step for obtaining the threshold data on the basis of the histogram generated in the second histogram generation step.

23. The image display method according to claim 22, wherein, in the threshold data calculation step, a luminance or tone with a maximum occurrence frequency among all possible luminances or tones for the input image is set as the threshold data on the basis of the histogram.

24. The image display method according to claim 22, wherein, in the threshold data calculation step, luminance or tone data indicating an occurrence frequency of a predetermined fifth specific value or more is extracted on the basis of the histogram, and an average among the extracted data is set as the threshold data.
